(19) United States
(12) Patent Application Publication
(10) Pub. No.: US 2012/0050184 A1
(43) Pub. Date: Mar. 1, 2012

(54) METHOD OF CONTROLLING DRIVING OF TOUCH PANEL

(75) Inventors: Dong Sik Yoo, Gyunggi-do (KR); Hee Bum Lee, Gyunggi-do (KR); Kyoung Soo Chae, Seoul (KR); Yong Soo Oh, Gyunggi-do (KR); Jong Young Lee, Gyunggi-do (KR); Yun Ki Hong, Gyunggi-do (KR)

(73) Assignee: SAMSUNG ELECTRO-MECHANICS CO., LTD., Gyunggi-do (KR)

(21) Appl. No.: 12/950,057

(22) Filed: Nov. 19, 2010

(30) Foreign Application Priority Data
Aug. 30, 2010 (KR) 1020100084149

(51) Int. Cl. G06F 3/041; G06F 3/01

(52) U.S. Cl. 345/173; 715/702

(57) ABSTRACT

Disclosed herein is a method of controlling driving of a touch panel. Input means inputs a first touch to a touch surface, and whether the first touch is a line touch is determined. If the first touch is a line touch, the touch surface is divided into first and second selection regions, based on the line touch. The input means inputs a second touch to the touch surface, and one of the first and second selection regions is selected. When the first selection region is selected by the second touch, if the input means inputs a third touch to the second selection region, a specific algorithm is executed in the second selection region, whereas when the second selection region is selected by the second touch, if the input means inputs the third touch to the first selection region, the specific algorithm is executed in the first selection region.

### CROSS REFERENCE TO RELATED APPLICATION

This application claims the benefit of Korean Patent Application No. 10-2010-0084149, filed on Aug. 30, 2010, entitled “Drive Control Method for Touch Panel”, which is hereby incorporated by reference in its entirety into this application.

### BACKGROUND OF THE INVENTION

1. Technical Field

The present invention relates generally to a method of controlling the driving of a touch panel.

2. Description of the Related Art

Auxiliary devices for computers have developed alongside the development of computers using digital technology. Personal computers, portable transmission devices, other private information processing devices, etc. perform text and graphic processing using various types of input devices such as a keyboard and a mouse.

However, with the rapid progress of an information-oriented society, the trend is for the use of computers is to gradually expand. Therefore, there is a problem in that it is difficult to efficiently drive products with just a keyboard and a mouse which function as current input devices. Therefore, there is an increased necessity for devices which not only have a simple structure and low erroneous manipulation, but which also enable anyone to easily input information.

Further, technology for input devices is exceeding just the current level which satisfies typical functions, and an interest in the typical functions has changed to an interest in high reliability, durability, innovation, design, processing-related technology, etc. In order to satisfy this interest, a touch panel has been developed as an input device enabling information such as text and graphic information to be input.

Such a touch panel is a tool which is installed on the display surface of an image display device such as an electronic scheduler, a Flat Panel Display (FPD), for example, a Liquid Crystal Display (LCD) device, a Plasma Display Panel (PDP), and an electroluminescence device, and a Cathode Ray Tube (CRT), and which is used to allow a user to select desired information while viewing the image display device.

Touch panels are classified into a resistive type, a capacitive type, an electro-magnetic type, a Surface Acoustic Wave (SAW) type, and an infrared type. Various types of touch panels are employed in electronic products in consideration of the problems of signal amplification, differences in resolution, the degree of difficulty in design and processing technology, optical characteristics, electrical characteristics, mechanical characteristics, environment resistant characteristics, input characteristics, durability, and economic efficiency. At present, types of panels that have been used in the most widely fields are resistive type touch panel and a capacitive type touch panel.

Meanwhile, conventional touch panels enable only the function of detecting coordinates to be realized. However, as recognition technology for touch panels has been developed, multi-touch and gesture can be recognized, so that various algorithms can be executed. However, in actuality, technology that effectively executes algorithms for recognizing multi-touch and gesture and editing electronic books (E-books), pictures, etc. is still insufficient. Therefore, there is a disadvantage in that when a user edits E-books or edits pictures, users must perform touching in a complicated and multiple touch manner, or alternatively, utilize an additional input device such as a keyboard or a mouse.

### SUMMARY OF THE INVENTION

Accordingly, the present invention has been made keeping in mind the above problems occurring in the prior art, and the present invention is intended to provide a method of controlling the driving of a touch panel, which divides a touch surface using a line touch or a surface touch, thus executing various algorithms.

In accordance with a first aspect of the present invention, there is provided a method of controlling driving of a touch panel, including (A) input means inputting a first touch to a touch surface, and determining whether the first touch is a line touch, (B) if it is determined that the first touch is a line touch, dividing the touch surface into a first selection region and a second selection region, based on the line touch, (C) the input means inputting a second touch to the touch surface and selecting one of the first selection region and the second selection region, and (D) when the first selection region is selected by the second touch, if the input means inputs a third touch to the second selection region, executing a specific algorithm in the second selection region, whereas when the second selection region is selected by the second touch, if the input means inputs the third touch to the first selection region, executing the specific algorithm in the first selection region.

In an embodiment, the determining whether the first touch is the line touch may be configured to determine that the first touch is a line touch when a length of the first touch is equal to or greater than a specific percentage of a length of a vertical line which connects parallel boundaries of the touch surface.

In an embodiment, the determining whether the first touch is the line touch may be configured to detect the first touch as a point and calculate coordinates of the point if the first touch is a point touch.

In an embodiment, the first touch may be sustained until the specific algorithm is executed in the second selection region or the first selection region.

In an embodiment, the executing the specific algorithm in the second selection region or the first selection region may be configured such that in a case where when the first selection region is selected by the second touch, the input means inputs the third touch to the first selection region, or in a case where when the second selection region is selected by the second touch, the input means inputs the third touch to the second selection region, the specific algorithm is not executed and the third touch is input again.

In an embodiment, the executing the specific algorithm in the second selection region or the first selection region may be configured such that when the specific algorithm is executed in the second selection region, an image displayed in the second selection region is stored or deleted, and when the specific algorithm is executed in the first selection region, an image displayed in the first selection region is stored or deleted.

In an embodiment, the executing the specific algorithm in the second selection region or the first selection region may be configured such that in a case where the third touch is moved to a boundary of the touch surface, when the specific algorithm is executed in the second selection region, an image displayed in the second selection region is moved to the boundary of the touch surface in a shape in which the image is torn with respect to the line touch, and when the specific algorithm is executed in the first selection region, an image displayed in the first selection region is moved to the boundary of the touch surface in a shape in which the image is torn with respect to the line touch.

In an embodiment, the executing the specific algorithm in the second selection region or the first selection region may be configured such that in a case where the third touch is concentrated from a plurality of points into a single point, when the specific algorithm is executed in the second selection region, an image displayed in the second selection region is shrunken in a shape in which the image is crumpled around the single point; and when the specific algorithm is executed in the first selection region, an image displayed in the first selection region is shrunken in a shape in which the image is crumpled around the single point.

In accordance with a second aspect of the present invention, there is provided a method of controlling driving of a touch panel, including (A) input means inputting a first touch to a touch surface, and determining whether the first touch is a surface touch, (B) if it is determined that the first touch is a surface touch, dividing the touch surface into a first selection region to which the surface touch is input, and a second selection region other than the first selection region, and (C) when the input means inputs a second touch to the second selection region, executing a specific algorithm in the second selection region.

In an embodiment, the determining whether the first touch is the surface touch may be configured to determine that the first touch is a surface touch when an area of the first touch is equal to or greater than a specific percentage of an area of a rectangle defined by two vertical lines, which connect parallel boundaries of the touch surface while passing through both ends of the first touch, and the boundaries of the touch surface.

In an embodiment, the determining whether the first touch is the surface touch may be configured to detect the first touch as a point and calculate coordinates of the point if the first touch is a point touch.

In an embodiment, the first touch may be sustained until the specific algorithm is executed in the second selection region.

In an embodiment, the executing the specific algorithm in the second selection region may be configured such that when the input means inputs the second touch to the first selection region, the specific algorithm is not executed and the second touch is input again.

In an embodiment, the executing the specific algorithm in the second selection region may be configured such that the specific algorithm is executed to store or delete an image displayed in the second selection region.

In an embodiment, the executing the specific algorithm in the second selection region may be configured such that when the second touch is moved to a boundary of the touch surface, the specific algorithm is executed to move an image displayed in the second selection region to the boundary of the touch surface in a shape in which the image is torn with respect to the surface touch.

In an embodiment, the executing the specific algorithm in the second selection region may be configured such that when the second touch is concentrated from a plurality of points into a single point, the specific algorithm is executed such that an image displayed in the second selection region is shrunken in a shape in which the image is crumpled around the single point.

### BRIEF DESCRIPTION OF THE DRAWINGS

FIG. 1 is a flowchart showing a method of controlling the driving of a touch panel according to a first embodiment of the present invention;

FIGS. 2 to 5 are diagrams sequentially showing the operations of the method of controlling the driving of a touch panel according to the first embodiment of the present invention;

FIG. 6 is a flowchart showing a method of controlling the driving of a touch panel according to a second embodiment of the present invention; and

FIGS. 7 to 9 are diagrams sequentially showing the operations of the method of controlling the driving of a touch panel according to the second embodiment of the present invention.

### DESCRIPTION OF THE PREFERRED EMBODIMENTS

Prior to giving the description, the terms and words used in the present specification and claims should not be interpreted as being limited to their typical meaning based on the dictionary definitions thereof, but should be interpreted to have the meaning and concept relevant to the technical spirit of the present invention on the basis of the principle by which the inventor can suitably define the implications of terms in the way which best describes the invention.

The above and other objects, features and advantages of the present invention will be more clearly understood from the following detailed description taken in conjunction with the accompanying drawings. In the present specification, reference now should be made to the drawings, in which the same reference numerals are used throughout the different drawings to designate the same or similar components. Further, the terms “first”, “second”, etc. are used to distinguish one component from other components, and components of the present invention are not limited by those terms. Further, in the description of the present invention, if detailed descriptions of related well-known constructions or functions are determined to make the gist of the present invention unclear, the detailed descriptions will be omitted.

For reference, the term ‘touch’ used throughout the entire specification of the present invention is interpreted as an operation that enables an input means to approach a touch surface to be within a predetermined distance in the wide meaning, as well as referring to direct contact with the touch surface. That is, the touch panel according to the present invention should be interpreted as a touch panel provided with the function of detecting the contact of the input means or detecting the approach of the input means to be within a predetermined distance of the touch surface.

Hereinafter, embodiments of the present invention will be described in detail with reference to the attached drawings.

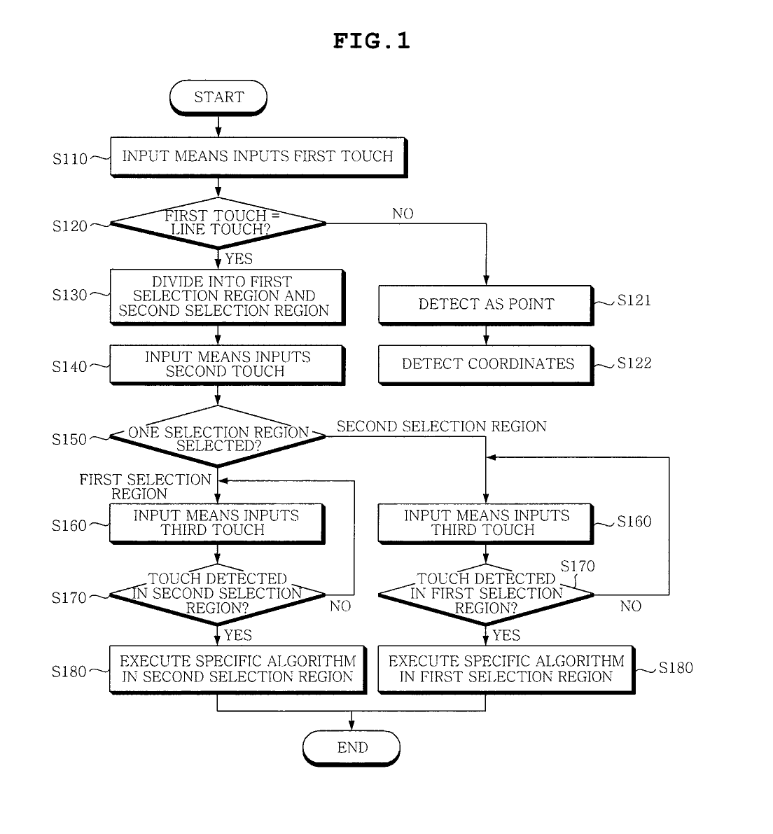

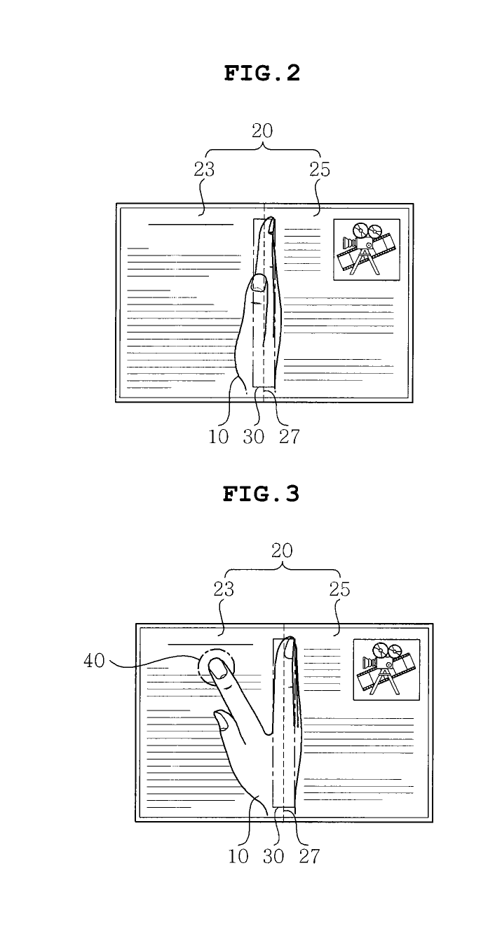

FIG. 1 is a flowchart showing a method of controlling the driving of a touch panel according to a first embodiment of the present invention, and FIGS. 2 to 5 are diagrams sequentially showing the operations of the method of controlling the driving of a touch panel according to the first embodiment of the present invention.

As shown in FIGS. 1 to 5, the method of controlling the driving of a touch panel according to the present embodiment includes (A) to (D). In (A), an input means 10 inputs a first touch 30 to a touch surface 20, and it is determined whether the first touch 30 is a line touch. In (B), if it is determined that the first touch 30 is a line touch, the touch surface 20 is divided into a first selection region 23 and a second selection region 25 on the basis of the line touch. In (C), the input means 10 inputs a second touch 40 to the touch surface 20, so that one of the first selection region 23 and the second selection region 25 is selected. In (D), when the first selection region 23 was selected by the second touch 40, if the input means 10 inputs a third touch 50 to the second selection region 25, a specific algorithm is executed in the second selection region 25. Further, in (D), when the second selection region 25 was selected by the second touch 40, if the input means 10 inputs a third touch 50 to the first selection region 23, a specific algorithm is executed in the first selection region 23.

As shown in FIG. 2, the input means 10 inputs the first touch 30 to the touch surface 20 (S110, refer to FIG. 1 for the sequence of individual operations), and it is determined whether the first touch 30 is a line touch (S120). Here, the first touch 30 may be either a line touch or a point touch. The criteria for determining a line touch or a point touch is whether the length of the first touch 30 is equal to or greater than a specific percentage of the length of a vertical line 27 which connects the parallel boundaries of the touch surface 20. That is, when the length of the first touch 30 is less than the specific percentage of the length of the vertical line 27, the first touch 30 is detected as a point touch, whereas when the length of the first touch 30 is equal to or greater than the specific percentage of the length of the vertical line 27, the first touch 30 is detected as a line touch. In this case, the specific percentage may be selected in consideration of the ratio of the length of the input means 10 (the user's hand) to the length of the touch surface 20. Preferably, such a length ratio may be 70% to 80%. When the first touch 30 is detected as a point touch (S121), a coordinate detection function for a typical touch panel is performed (S122). That is, the touch panel detects the first touch 30 as a point and calculates the coordinates of the point. Meanwhile, in the drawings, a line touch is shown to be made with a finger extended straight, but the line touch of the present invention is not limited to this example, and the line touch may be input by laying down a predetermined object (for example, a stylus pen or the like) having a one-dimensional length.

Next, when the first touch 30 is a line touch, the touch surface 20 is divided into the first selection region 23 and the second selection region 25 on the basis of the line touch (S130). For example, as shown in the drawings, when a line touch that perpendicularly connects the parallel upper and lower boundaries of the touch surface 20 is input, the first selection region 23 and the second selection region 25 are respectively defined on the left and right sides of the line touch. In addition, a line touch that perpendicularly connects parallel left and right boundaries of the touch surface 20 may be input. In this case, it is apparent that the first selection region 23 and the second selection region 25 are respectively defined on the upper and lower sides of the line touch. In the present operation, the touch surface 20 is divided into two selection regions, thus enabling an algorithm to be selectively executed in only one of the two selection regions 23 and 25 in a subsequent operation which will be described later.

Next, as shown in FIG. 3, the input means 10 inputs the second touch 40 to the touch surface 20 (S140), so that one of the first selection region 23 and the second selection region 25 is selected (S150). In the present operation, the second touch 40 may be input by using one finger in the state in which another finger is extended straight to make a line touch. In this case, the second touch 40 is intended to select a selection region in which an algorithm is not executed in the subsequent operation. That is, when the second touch 40 selects the first selection region 23, the algorithm is not executed in the first selection region 23. Further, when the second touch 40 selects the second selection region 25, the algorithm is not executed in the second selection region 25. Meanwhile, in the drawings, the second touch 40 is shown to select the first selection region 23, but this is only exemplary, and it is apparent that the second touch 40 may select the second selection region 25.

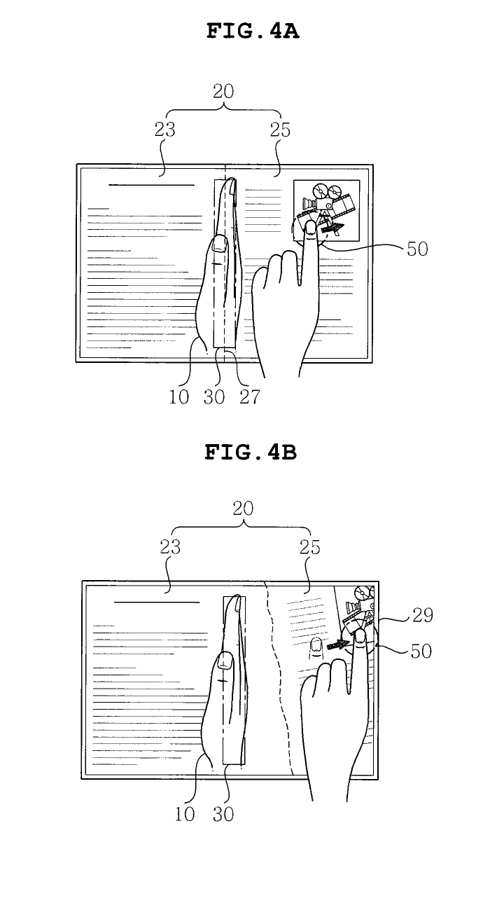

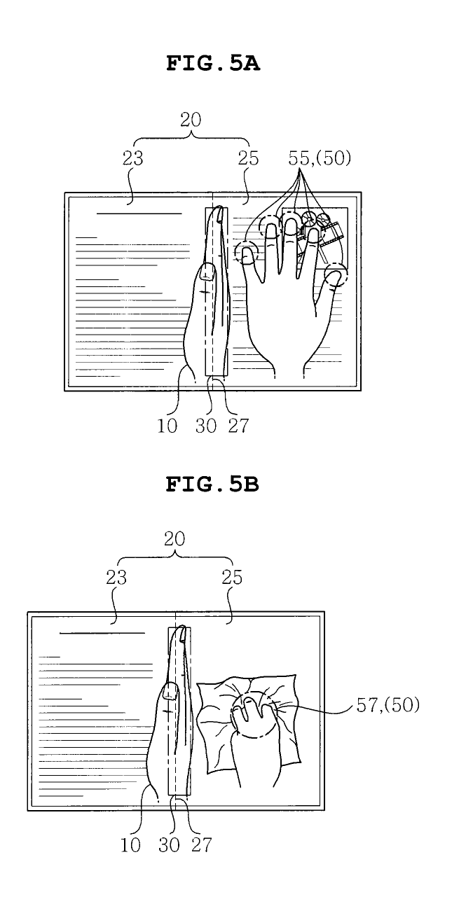

Next, as shown in FIGS. 4A and 4B and 5A and 5B, when the input means 10 inputs the third touch 50 to a selection region which was not selected by the second touch 40 (S160), a specific algorithm is executed (S180). As shown in the drawings, when the first selection region 23 was selected by the second touch 40 in the above-described operation, if the input means 10 inputs a third touch 50 to the second selection region 25, a specific algorithm is executed in the second selection region 25. Here, the specific algorithm includes an operation of editing an image displayed in the second selection region 25 as well as a memory-related operation such as storing or deleting the image displayed in the second selection region 25. For example, as shown in FIGS. 4A and 4B, when the third touch 50 is moved to the boundary 29 of the touch surface 20, the image displayed in the second selection region 25 can be moved to the boundary 29 of the touch surface 20 in a shape in which the image is torn with respect to the line touch. It is assumed that the images displayed on the touch surface 20 are first and second pages of an E-book, and the touch surface is divided into the first selection region 23 and the second selection region 25 on the basis of the border between the first and second pages to select the first selection region 23 corresponding to the first page by using the second touch 40. In this case, when the third touch 50 is moved to the boundary 29 of the touch surface 20 in the second selection region 25 corresponding to the second page, the second page is moved to the boundary of the touch surface 20 in a torn shape. Further, as shown in FIGS. 5A and 5B, when the third touch 50 is concentrated from a plurality of points 55 into a single point 57, the image displayed in the second selection region 25 may be shrunken in a shape in which the image is crumpled around the single point 57. Meanwhile, it is assumed that the images displayed on the touch surface 20 are first and second pages of an E-book, and the touch surface 20 is divided into the first selection region 23 and the second selection region 25 based on the border between the first and second pages to select the first selection region 23 corresponding to the first page by using the second touch 40. In this case, when the third touch 50 is concentrated from a plurality of points 55 into a single point 57 in the second selection region 25 corresponding to the second page, the second page is shrunken in a shape in which it is crumpled around the single point 57. As described above, moving gesture or concentrating gesture is recognized, so that various algorithms are executed, thus obtaining an advantage in that the user can visually and easily edit E-books, pictures, etc. Meanwhile, the above description has been made on the basis of the embodiment in which the first selection region 23 is selected by the second touch 40, but the present invention is not limited to this embodiment. When the second selection region 25 is selected by the second touch 40, and the third touch 40 is input to the first selection region 23, the specific algorithm is executed in the first selection region 23 using the same method as the above method.

Further, a specific algorithm may be executed only when the third touch 50 is input to a selection region which was not selected by the second touch 40. Therefore, when the third touch 50 is input to the selection region selected by the second touch 40, the specific algorithm is not executed, and the third touch 50 is input again (S170). That is, in the case where when the first selection region 23 was selected by the second touch 40, the input means 10 inputs the third touch 50 to the first selection region 23, or in the case where when the second selection region 25 was selected by the second touch 40, the input means 10 inputs the third touch 50 to the second selection region 25, a specific algorithm is not executed, and the third touch 50 is input again.

Since the touch panel enables multi-touch, the first touch 30 can be sustained until the specific algorithm is executed. However, if necessary, the first touch 30 can be removed from the touch surface 20 immediately after it has been determined whether the first touch 30 was a line touch (S120).

The method of controlling the driving of the touch panel according to the present embodiment divides the touch surface 20 using a line touch, so that various algorithms can be executed, thus obtaining an advantage in which the user can effectively edit images such as those in E-books or pictures.

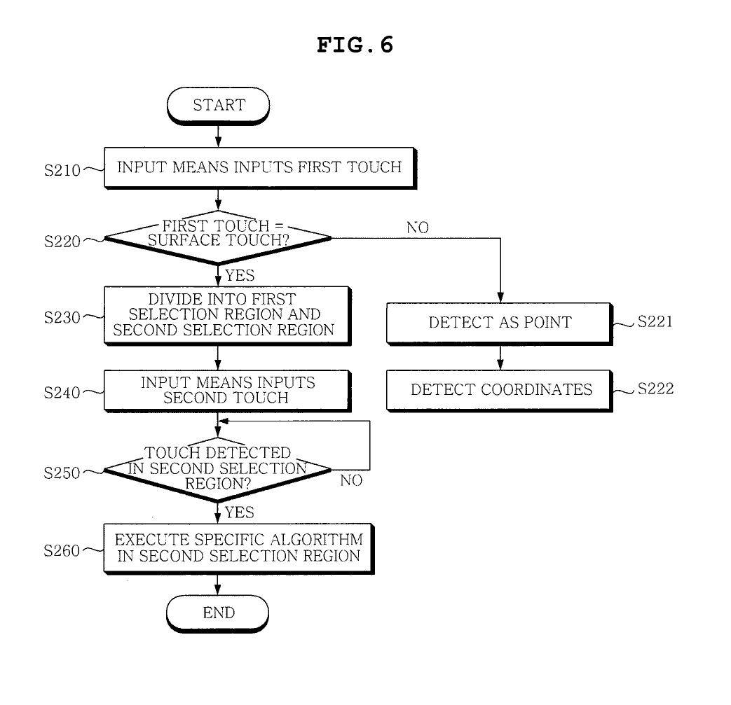

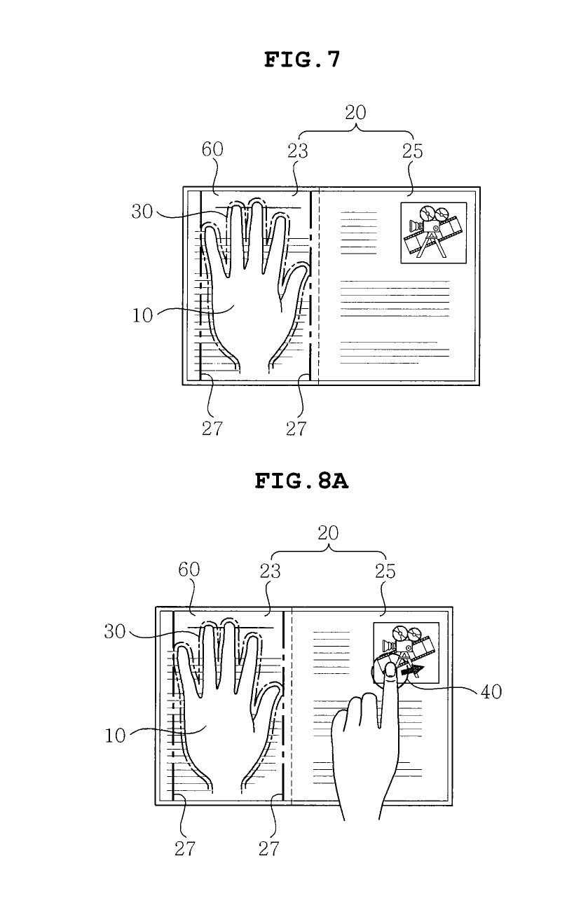

FIG. 6 is a flowchart showing a method of controlling the driving of a touch panel according to a second embodiment of the present invention, and FIGS. 7 to 9 are diagrams sequentially showing operations of the method of controlling the driving of a touch panel according to the second embodiment of the present invention.

As shown in FIGS. 6 to 9, the method of controlling the driving of a touch panel according to the present embodiment includes (A) to (C). In (A), an input means 10 inputs a first touch 30 to a touch surface 20, and it is determined whether the first touch 30 is a surface touch. In (B), if it is determined that the first touch 30 is a surface touch, the touch surface 20 is divided into a first selection region 23 to which the surface touch is input, and a second selection region 25 other than the first selection region 23. In (C), when the input means 10 inputs a second touch 40 to the second selection region 25, a specific algorithm is executed in the second selection region 25.

First, as shown in FIG. 7, the input means 10 inputs the first touch 30 to the touch surface 20 (S210; refer to FIG. 6 for the sequence of individual operations), and it is determined whether the first touch 30 is a surface touch (S220). In this case, the first touch 30 may be a surface touch or a point touch. The criteria for determining a surface touch or a point touch is whether the area of the first touch 30 is equal to or greater than a specific percentage of the area of a rectangle defined by two vertical lines 27, which connect parallel boundaries of the touch surface 20 while passing through both ends of the first touch 30, and the boundaries of the touch surface 20. That is, when the area of the first touch 30 is less than the specific percentage of the area of the rectangle 60, the first touch 30 is detected as a point touch. In contrast, when the area of the first touch 30 is equal to or greater than the specific percentage of the area of the rectangle 60, the first touch 30 is detected as a surface touch. Here, the specific percentage may be selected in consideration of the ratio of the area of the input means 10 (the user's hand) to the area of the touch surface 20. Such an area ratio may preferably be 70% to 80%. If the first touch 30 is detected as a point touch (S221), the function of detecting the coordinates of a typical touch panel is performed (S222). That is, the touch panel detects the first touch 30 as a point and calculates the coordinates of the point. Meanwhile, in the drawings, the embodiment in which the palm of the hand comes into contact with the touch surface 20 with all the fingers extended straight so as to input a surface touch is shown. However, a surface touch is not necessarily limited to this embodiment, and it is possible to input a surface touch to the touch surface 20 using a predetermined object having a two-dimensional area.

Next, when the first touch 30 is a surface touch, the touch surface 20 is divided into a first selection region 23 to which the surface touch is input, and a second selection region 25 other than the first selection region 23 (S230). Here, the first selection region 23 may be defined as a rectangle 60 defined by two vertical lines 27, which connect the parallel boundaries of the touch surface 20 while passing through both ends of the first touch 30, and the boundaries of the touch surface 20. For example, as shown in the drawings, when a surface touch that perpendicularly connects parallel upper and lower boundaries of the touch surface 20 is made, the first selection region 23 and the second selection region 25 are respectively defined on left and right sides on the basis of the surface touch. In addition, it is possible to input a surface touch that perpendicularly connects parallel left and right boundaries of the touch surface 20. In this case, it is apparent that the first selection region 23 and the second selection region 25 are respectively defined on upper and lower sides on the basis of the surface touch. Meanwhile, when the second selection region 25 is defined on both sides of the first selection region 23, one of the two second selection regions 25 on both sides of the first selection region 23, that is, a selection region 25 having a relatively small area, can be defined as the first selection region 23 for the sake of convenient editing. In the present operation, the touch surface 20 is divided into two selection regions, thus enabling an algorithm to be selectively executed in only one of the two selection regions 23 and 25 in a subsequent operation which will be described later.

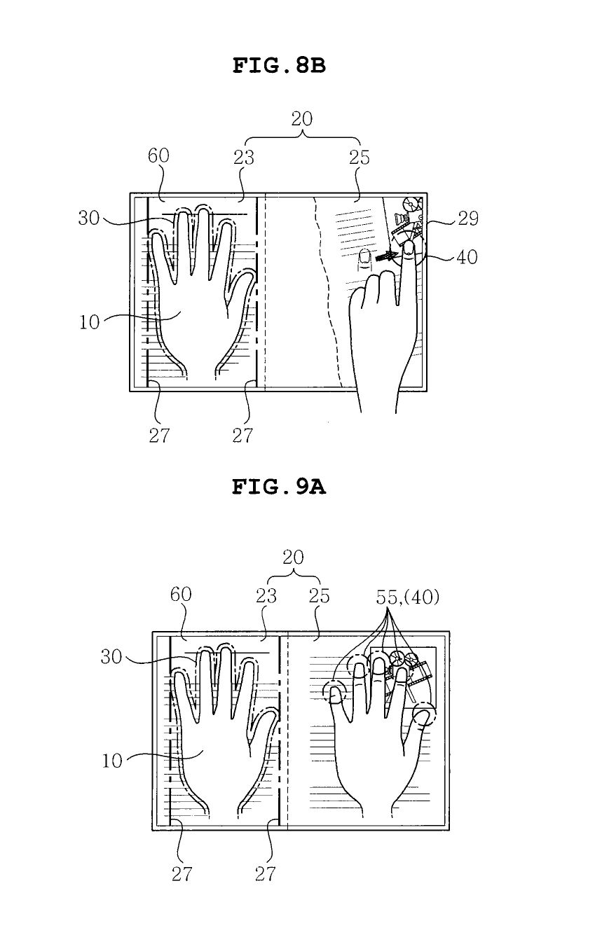

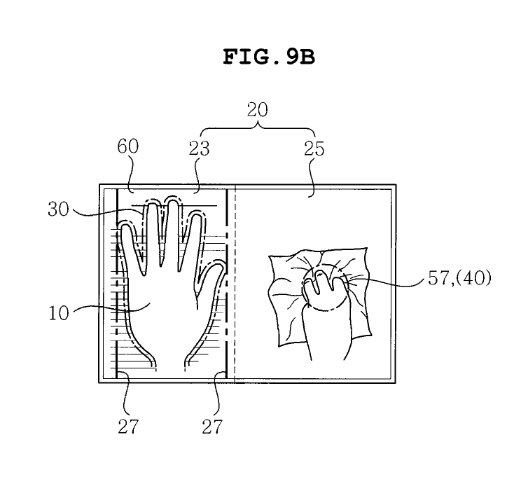

Next, as shown in FIGS. 8A and 8B and 9A and 9B, when the input means 10 inputs the second touch 40 to the second selection region 25 (S240), a specific algorithm is executed in the second selection region 25 (S260). Here, the specific algorithm includes an operation of editing an image displayed in the second selection region 25 as well as a memory-related operation such as storing or deleting the image displayed in the second selection region 25. For example, as shown in FIGS. 8A and 8B, when the second touch 40 is moved to the boundary 29 of the touch surface 20, the image displayed in the second selection region 25 can be moved to the boundary 29 of the touch surface 20 in a shape in which the image is torn with respect to the surface touch. It is assumed that the images displayed on the touch surface 20 are first and second pages of an E-book, and that the touch surface is divided into the first selection region 23 and the second selection region 25 on the basis of the border between the first and second pages. In this case, when the second touch 40 is moved to the boundary 29 of the touch surface 20 in the second selection region 25 corresponding to the second page, the second page is moved to the boundary 29 of the touch surface 20 in a torn shape. Further, as shown in FIGS. 9A and 9B, when the second touch 40 is concentrated from a plurality of points 55 into a single point 57, the image displayed in the second selection region 25 may be shrunken in a shape in which the image is crumpled around the single point 57. Meanwhile, it is assumed that images displayed on the touch surface 20 are first and second pages of an E-book, and the touch surface 20 is divided into the first selection region 23 and the second selection region 25 on the basis of the border between the first and second pages. In this case, when the second touch 40 is concentrated from a plurality of points 55 into a single point 57 in the second selection region 25 corresponding to the second page, the second page may be shrunken in a shape in which it is crumpled around the single point 57. As described, various algorithms are executed by recognizing moving gesture or concentrating gesture, thus obtaining an advantage in that the user can visually and easily edit E-books or pictures.

Further, the specific algorithm can be executed only when the second touch 40 is input to the second selection region 25. Accordingly, when the second touch 40 is input to the first selection region 23, the specific algorithm is not executed, and the second touch 40 is input again.

Since the touch panel enables multi-touch, the first touch 30 can be sustained until the specific algorithm is executed. However, if necessary, the first touch 30 can be removed from the touch surface 20 immediately after it has been determined whether the first touch 30 was a surface touch (S220).

The method of controlling the driving of the touch panel according to the present embodiment divides the touch surface 20 using a surface touch, so that various algorithms can be executed, thus obtaining an advantage in which the user can effectively edit images such as those in E-books or pictures.

Meanwhile, the above-described first and second embodiments differ in the sense that they use a line touch and a surface touch, respectively. However, it is apparent that a line touch and a surface touch are not necessarily implemented in separate touch panels, and that a method of controlling the driving of a touch panel, which can use both a line touch and a surface touch by utilizing the first and second embodiments in combination, is also included in the scope of the present invention.

As described above, the present invention provides a method of controlling the driving of a touch panel, which is advantageous in that various algorithms are executed by dividing a touch surface using a line touch, thus allowing a user to effectively edit images such as those in E-books or pictures.

Further, the present invention is advantageous in that moving gesture or concentrating gesture is recognized, so that various algorithms are executed, thus allowing a user to visually and easily edit E-books or pictures.

Although the preferred embodiments of the present invention have been disclosed for illustrative purposes, those skilled in the art will appreciate that the embodiments are intended to describe the present invention in detail, and the method of controlling the driving of a touch panel according to the present invention is not limited to those embodiments, and that various modifications, additions and substitutions are possible, without departing from the scope and spirit of the invention as disclosed in the accompanying claims above. Simple modifications or changes of the present invention belong to the scope of the present invention, and the detailed scope of the present invention will be clarified by the accompanying claims.

What is claimed is:

1. A method of controlling driving of a touch panel, comprising:
(A) input means inputting a first touch to a touch surface, and determining whether the first touch is a line touch;
(B) if it is determined that the first touch is a line touch, dividing the touch surface into a first selection region and a second selection region, based on the line touch;
(C) the input means inputting a second touch to the touch surface and selecting one of the first selection region and the second selection region; and
(D) when the first selection region is selected by the second touch, if the input means inputs a third touch to the second selection region, executing a specific algorithm in the second selection region, whereas when the second selection region is selected by the second touch, if the input means inputs the third touch to the first selection region, executing the specific algorithm in the first selection region.

2. The method as set forth in claim 1, wherein the determining whether the first touch is the line touch is configured to determine that the first touch is a line touch when a length of the first touch is equal to or greater than a specific percentage of a length of a vertical line which connects parallel boundaries of the touch surface.

3. The method as set forth in claim 1, wherein the determining whether the first touch is the line touch is configured to detect the first touch as a point and calculate coordinates of the point if the first touch is a point touch.

4. The method as set forth in claim 1, wherein the first touch is sustained until the specific algorithm is executed in the second selection region or the first selection region.

5. The method as set forth in claim 1, wherein the executing the specific algorithm in the second selection region or the first selection region is configured such that in a case where when the first selection region is selected by the second touch, the input means inputs the third touch to the first selection region, or in a case where when the second selection region is selected by the second touch, the input means inputs the third touch to the second selection region, the specific algorithm is not executed and the third touch is input again.

6. The method as set forth in claim 1, wherein the executing the specific algorithm in the second selection region or the first selection region is configured such that,
when the specific algorithm is executed in the second selection region, an image displayed in the second selection region is stored or deleted, and
when the specific algorithm is executed in the first selection region, an image displayed in the first selection region is stored or deleted.

7. The method as set forth in claim 1, wherein the executing the specific algorithm in the second selection region or the first selection region is configured such that in a case where the third touch is moved to a boundary of the touch surface,
when the specific algorithm is executed in the second selection region, an image displayed in the second selection region is moved to the boundary of the touch surface in a shape in which the image is torn with respect to the line touch, and
when the specific algorithm is executed in the first selection region, an image displayed in the first selection region is moved to the boundary of the touch surface in a shape in which the image is torn with respect to the line touch.

8. The method as set forth in claim 1, wherein the executing the specific algorithm in the second selection region or the first selection region is configured such that in a case where the third touch is concentrated from a plurality of points into a single point,
when the specific algorithm is executed in the second selection region, an image displayed in the second selection region is shrunken in a shape in which the image is crumpled around the single point; and
when the specific algorithm is executed in the first selection region, an image displayed in the first selection region is shrunken in a shape in which the image is crumpled around the single point.

9. A method of controlling driving of a touch panel, comprising:
(A) input means inputting a first touch to a touch surface, and determining whether the first to touch is a surface touch;
(B) if it is determined that the first touch is a surface touch, dividing the touch surface into a first selection region to which the surface touch is input, and a second selection region other than the first selection region; and
(C) when the input means inputs a second touch to the second selection region, executing a specific algorithm in the second selection region.

10. The method as set forth in claim 9, wherein the determining whether the first touch is the surface touch is configured to determine that the first touch is a surface touch when an area of the first touch is equal to or greater than a specific percentage of an area of a rectangle defined by two vertical lines, which connect parallel boundaries of the touch surface while passing through both ends of the first touch, and the boundaries of the touch surface.

11. The method as set forth in claim 9, wherein the determining whether the first touch is the surface touch is configured to detect the first touch as a point and calculate coordinates of the point if the first touch is a point touch.

12. The method as set forth in claim 9, wherein the first touch is sustained until the specific algorithm is executed in the second selection region.

13. The method as set forth in claim 9, wherein the executing the specific algorithm in the second selection region is configured such that when the input means inputs the second touch to the first selection region, the specific algorithm is not executed and the second touch is input again.

14. The method as set forth in claim 9, wherein the executing the specific algorithm in the second selection region is configured such that the specific algorithm is executed to store or delete an image displayed in the second selection region.

15. The method as set forth in claim 9, wherein the executing the specific algorithm in the second selection region is configured such that when the second touch is moved to a boundary of the touch surface, the specific algorithm is executed to move an image displayed in the second selection region to the boundary of the touch surface in a shape in which the image is torn with respect to the surface touch.

16. The method as set forth in claim 9, wherein the executing the specific algorithm in the second selection region is configured such that when the second touch is concentrated from a plurality of points into a single point, the specific algorithm is executed such that an image displayed in the second selection region is shrunken in a shape in which the image is crumpled around the single point.
